(19) United States
(12) Patent Application Publication
(10) Pub. No.: US 2026/0184303 A1
(43) Pub. Date: Jul. 2, 2026

(54) System for Proactive Traffic Hazard Mitigation

(71) Applicant: Nissan North America, Inc., Franklin, TN (US)

(72) Inventors: Qizhan Tam, San Jose, CA (US); Christopher Ostafew, Mountain View, CA (US)

(21) Appl. No.: 19/004,892

(22) Filed: Dec. 30, 2024

(51) Int. Cl. B60W 30/09; B60W 30/095; B60W 30/14; B60W 60/00

(52) U.S. Cl. CPC B60W 30/09; B60W 30/0956; B60W 30/146; B60W 60/0015; B60W 2520/10; B60W 2554/4042; B60W 2554/4045; B60W 2554/406; B60W 2554/801

(57) ABSTRACT

Proactively mitigating traffic hazards includes receiving hazard data from a risk field adjacent to a path of a vehicle A width of the risk field extends laterally from the vehicle in both directions and the hazard data is stored for each unit distance of the path. Base parameters are determined based on the hazard data and a defined longitudinal constraint extending from a front of the vehicle. The base parameters include at least one of an average speed difference, an average lateral distance, or a density of adjacent vehicles per unit distance. A risk level is calculated for the vehicle based on the base parameters. A speed constraint is generated based on the risk level and the speed constraint is used to limit a maximum speed of the vehicle.

### TECHNICAL FIELD

This application relates to communication systems for autonomous vehicles, specifically to methods and apparatus for proactively mitigating traffic hazards.

### BACKGROUND

Autonomous vehicles (AVs) are designed to navigate complex environments that are often filled with various hazards, both static and dynamic. These hazards can include other vehicles, pedestrians, cyclists, and unexpected obstacles such as debris or construction zones. For autonomous vehicles to operate safely and efficiently, it is critical to detect these hazards accurately and assess their potential impact on the vehicle's path. Proper hazard detection and assessment enable the vehicle to make informed decisions, avoid collisions, and ensure a smooth and safe driving experience.

### SUMMARY

Disclosed herein are aspects, features, elements, and implementations for mitigating traffic hazards for vehicle navigation.

A first aspect of the teachings herein is a method. The method includes receiving hazard data from a risk field adjacent to a path of a vehicle, wherein a width of the risk field extends laterally from the vehicle in both directions and the hazard data is stored for each unit distance of the path; determining base parameters based on the hazard data and a defined longitudinal constraint extending from a front of the vehicle, wherein the base parameters include at least one of an average speed difference, an average lateral distance, or a density of adjacent vehicles per unit distance; calculating a risk level for the vehicle based on the base parameters; generating a speed constraint based on the risk level; and using the speed constraint to limit a maximum speed of the vehicle.

A second aspect of the teachings herein is an apparatus that includes a memory subsystem and one or more processors. The one or more processors is configured to execute instructions stored in the memory subsystem to receive hazard data from a risk field adjacent to a path of a vehicle, wherein a width of the risk field extends laterally from the vehicle in both directions and the hazard data is stored for each unit distance of the path; determine base parameters based on the hazard data and a defined longitudinal constraint extending from a front of the vehicle, wherein the base parameters include at least one of an average speed difference, an average lateral distance, or a density of adjacent vehicles per unit distance; calculate a risk level for the vehicle based on the base parameters; generate a speed constraint based on the risk level; and use the speed constraint to limit a maximum speed of the vehicle.

A third aspect of the teachings herein is a non-transitory computer-readable medium storing instructions operable to cause one or more processors to perform operations that include receiving hazard data from a risk field adjacent to a path of a vehicle, wherein a width of the risk field extends laterally from the vehicle in both directions and the hazard data is stored for each unit distance of the path; determining base parameters based on the hazard data and a defined longitudinal constraint extending from a front of the vehicle, wherein the base parameters include at least one of an average speed difference, an average lateral distance, or a density of adjacent vehicles per unit distance; deriving calculation parameters from the base parameters, wherein the calculation parameters include at least an impact of an amount of damage to be incurred by the vehicle, a probability of an adjacent vehicle merging into the path, and a lateral distance factor; calculating a risk level for the vehicle using the calculation parameters; generating a speed constraint based on the risk level; and using the speed constraint to limit a maximum speed of the vehicle.

These and other aspects of the present disclosure are disclosed in the following detailed description of the implementations, the appended claims, and the accompanying figures.

### BRIEF DESCRIPTION OF THE DRAWINGS

The disclosed technology is best understood from the following detailed description when read in conjunction with the accompanying drawings. It is emphasized that, according to common practice, the various features of the drawings may not be to scale. On the contrary, the dimensions of the various features may be arbitrarily expanded or reduced for clarity. Further, like reference numbers refer to like elements throughout the drawings unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a block diagram of a system for proactive traffic hazard mitigation.

FIG. 4 is a flowchart of an example of a technique for mitigating traffic hazards.

FIG. 5 is an illustration of a representation of identified relevant hazards within the risk field.

FIG. 6 is an illustration of a representation of a calculated risk level.

FIG. 7 is an illustration of a speed constraint based on the identified relevant hazards.

### DETAILED DESCRIPTION

AVs frequently encounter various potential hazards, both static and dynamic, such as parked vehicles, pedestrians, and other moving objects. In particular, AVs may encounter dense traffic scenarios in which the risk of merging vehicles from adjacent lanes is high, even when those vehicles have not indicated an intention to merge. Proactive risk mitigation (PRM) is an approach to automatically mitigate risks from such hazards, ensuring a safe and human-like driving experience. However, current commercial systems primarily only react to objects directly in front of the vehicle and do not dynamically adjust speed based on the overall traffic situation. This limitation can lead to unsafe and uncomfortable driving experiences, especially when there is a potential for vehicles to merge from slow adjacent lanes into the path of the ego vehicle (i.e., the AV itself).

Implementations according to this disclosure solve problems such as these by dynamically adjusting the speed of the ego vehicle based on the risk level assessed from the surrounding traffic environment. This involves utilizing a risk field to track the current and predicted future positions of objects, such as other vehicles and pedestrians, and calculating a risk level based on factors like traffic density, average lateral distance to adjacent cars, and average vehicle speed difference. The calculated risk level is then used to adjust the speed of the ego vehicle, ensuring safer and more comfortable navigation through dense traffic scenarios.

The traffic hazard mitigation strategy described within offers several advantages over traditional approaches by addressing the limitations of current commercial systems. The traffic hazard mitigation strategy allows for dynamic speed adjustment based on the risk level assessed from the surrounding traffic environment, considering factors such as traffic density, average lateral distance to adjacent cars, and average vehicle speed difference. This proactive approach enhances safety and driving comfort by anticipating potential disruptions and proactively reducing speed, thereby replicating human-like driving behavior in complex traffic environments.

To describe some implementations of the system to communicate vehicle intent using projection according to the teachings herein in greater detail, reference is first made to the environment in which this disclosure may be implemented.

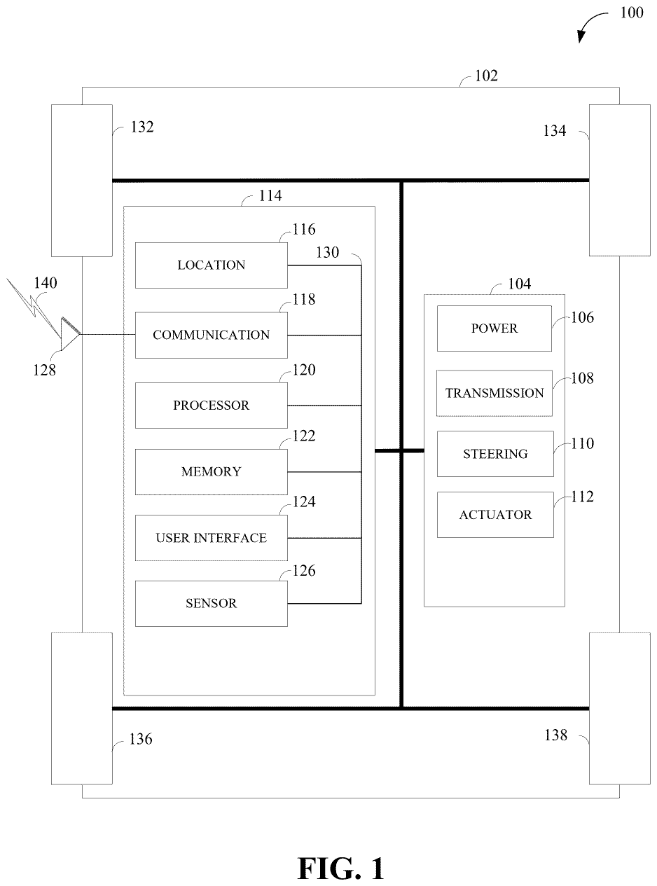

FIG. 1 is a diagram of an example of a portion of a vehicle 100 in which the aspects, features, and elements disclosed herein may be implemented. The vehicle 100 includes a chassis 102, a powertrain 104, a controller 114, wheels 132/134/136/138, and may include any other element or combination of elements of a vehicle. Although the vehicle 100 is shown as including four wheels 132/134/136/138 for simplicity, any other propulsion device or devices, such as a propeller or tread, may be used. In FIG. 1, the lines interconnecting elements, such as the powertrain 104, the controller 114, and the wheels 132/134/136/138, indicate that information, such as data or control signals; power, such as electrical power or torque; or both information and power may be communicated between the respective elements. For example, the controller 114 may receive power from the powertrain 104 and communicate with the powertrain 104, the wheels 132/134/136/138, or both, to control the vehicle 100, which can include accelerating, decelerating, steering, or otherwise controlling the vehicle 100.

The powertrain 104 includes a power source 106, a transmission 108, a steering unit 110, a vehicle actuator 112, and may include any other element or combination of elements of a powertrain, such as a suspension, a drive shaft, axles, or an exhaust system. Although shown separately, the wheels 132/134/136/138 may be included in the powertrain 104.

The power source 106 may be any device or combination of devices operative to provide energy, such as electrical energy, thermal energy, or kinetic energy. For example, the power source 106 includes an engine, such as an internal combustion engine, an electric motor, or a combination of an internal combustion engine and an electric motor, and is operative to provide kinetic energy as a motive force to one or more of the wheels 132/134/136/138. In some implementations, the power source 106 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 108 receives energy, such as kinetic energy, from the power source 106 and transmits the energy to the wheels 132/134/136/138 to provide a motive force. The transmission 108 may be controlled by the controller 114, the vehicle actuator 112, or both. The steering unit 110 may be controlled by the controller 114, the vehicle actuator 112, or both and controls the wheels 132/134/136/138 to steer the vehicle. The vehicle actuator 112 may receive signals from the controller 114 and may actuate or control the power source 106, the transmission 108, the steering unit 110, or any combination thereof to operate the vehicle 100.

In the illustrated implementation, the controller 114 includes a location unit 116, an electronic communication unit 118, a processor 120, a memory 122, a user interface 124, a sensor 126, and an electronic communication interface 128. Although shown as a single unit, any one or more elements of the controller 114 may be integrated into any number of separate physical units. For example, the user interface 124 and the processor 120 may be integrated in a first physical unit, and the memory 122 may be integrated in a second physical unit. Although not shown in FIG. 1, the controller 114 may include a power source, such as a battery. Although shown as separate elements, the location unit 116, the electronic communication unit 118, the processor 120, the memory 122, the user interface 124, the sensor 126, the electronic communication interface 128, or any combination thereof can be integrated in one or more electronic units, circuits, or chips.

In some implementations, the processor 120 includes any device or combination of devices, now existing or hereafter developed, capable of manipulating or processing a signal or other information, for example optical processors, quantum processors, molecular processors, or a combination thereof. For example, the processor 120 may include one or more special-purpose processors, one or more digital signal processors, one or more microprocessors, one or more controllers, one or more microcontrollers, one or more integrated circuits, one or more Application Specific Integrated Circuits, one or more Field Programmable Gate Arrays, one or more programmable logic arrays, one or more programmable logic controllers, one or more state machines, or any combination thereof. The processor 120 may be operatively coupled with the location unit 116, the memory 122, the electronic communication interface 128, the electronic communication unit 118, the user interface 124, the sensor 126, the powertrain 104, or any combination thereof. For example, the processor may be operatively coupled with the memory 122 via a communication bus 130.

The processor 120 may be configured to execute instructions. Such instructions may include instructions for remote operation, which may be used to operate the vehicle 100 from a remote location, including the operations center. The instructions for remote operation may be stored in the vehicle 100 or received from an external source, such as a traffic management center, or server computing devices, which may include cloud-based server computing devices. The processor 120 may also implement some or all of the proactive risk mitigation described herein.

The memory 122 may include any tangible non-transitory computer-usable or computer-readable medium capable of, for example, containing, storing, communicating, or transporting machine-readable instructions or any information associated therewith, for use by or in connection with the processor 120. The memory 122 may include, for example, one or more solid state drives, one or more memory cards, one or more removable media, one or more read-only memories (ROM), one or more random-access memories (RAM), one or more registers, one or more low power double data rate (LPDDR) memories, one or more cache memories, one or more disks (including a hard disk, a floppy disk, or an optical disk), a magnetic or optical card, or any type of non-transitory media suitable for storing electronic information, or any combination thereof.

The electronic communication interface 128 may be a wireless antenna, as shown, a wired communication port, an optical communication port, or any other wired or wireless unit capable of interfacing with a wired or wireless electronic communication medium 140.

The electronic communication unit 118 may be configured to transmit or receive signals via the wired or wireless electronic communication medium 140, such as via the electronic communication interface 128. Although not explicitly shown in FIG. 1, the electronic communication unit 118 is configured to transmit, receive, or both via any wired or wireless communication medium, such as radio frequency (RF), ultra violet (UV), visible light, fiber optic, wire line, or a combination thereof. Although FIG. 1 shows a single one of the electronic communication unit 118 and a single one of the electronic communication interface 128, any number of communication units and any number of communication interfaces may be used. In some implementations, the electronic communication unit 118 can include a dedicated short-range communications (DSRC) unit, a wireless safety unit (WSU), Institute of Electrical and Electronics Engineers (IEEE) 802.11p (WiFi-P), or a combination thereof.

The location unit 116 may determine geolocation information, including but not limited to longitude, latitude, elevation, direction of travel, or speed, of the vehicle 100. For example, the location unit includes a global positioning system (GPS) unit, such as a Wide Area Augmentation System (WAAS) enabled National Marine Electronics Association (NMEA) unit, a radio triangulation unit, or a combination thereof. The location unit 116 can be used to obtain information that represents, for example, a current heading of the vehicle 100, a current position of the vehicle 100 in two or three dimensions, a current angular orientation of the vehicle 100, or a combination thereof.

The user interface 124 may include any unit capable of being used as an interface by a person, including any of a virtual keypad, a physical keypad, a touchpad, a display, a touchscreen, a speaker, a microphone, a video camera, a sensor, and a printer. The user interface 124 may be operatively coupled with the processor 120, as shown, or with any other element of the controller 114. Although shown as a single unit, the user interface 124 can include one or more physical units. For example, the user interface 124 includes an audio interface for performing audio communication with a person, and a touch display for performing visual and touch-based communication with the person.

The sensor 126 may include one or more sensors, such as an array of sensors, which may be operable to provide information that may be used to control the vehicle. The sensor 126 can provide information regarding current operating characteristics of the vehicle or its surroundings. The sensor 126 includes, for example, a speed sensor, acceleration sensors, a steering angle sensor, traction-related sensors, braking-related sensors, or any sensor, or combination of sensors, that is operable to report information regarding some aspect of the current dynamic situation of the vehicle 100.

In some implementations, the sensor 126 includes sensors that are operable to obtain information regarding the physical environment surrounding the vehicle 100. For example, one or more sensors detect road geometry and obstacles, such as fixed obstacles, vehicles, cyclists, and pedestrians. The sensor 126 can be or include one or more video cameras, laser-sensing systems, infrared-sensing systems, acoustic-sensing systems, or any other suitable type of on-vehicle environmental sensing device, or combination of devices, now known or later developed. The sensor 126 and the location unit 116 may be combined.

Although not shown separately, the vehicle 100 may include a trajectory controller. For example, the controller 114 may include a trajectory controller. The trajectory controller may be operable to obtain information describing a current state of the vehicle 100 and a route planned for the vehicle 100, and, based on this information, to determine and optimize a trajectory for the vehicle 100. In some implementations, the trajectory controller outputs signals operable to control the vehicle 100 such that the vehicle 100 follows the trajectory that is determined by the trajectory controller. For example, the output of the trajectory controller can be an optimized trajectory that may be supplied to the powertrain 104, the wheels 132/134/136/138, or both. The optimized trajectory can be a control input, such as a set of steering angles, with each steering angle corresponding to a point in time or a position. The optimized trajectory can be one or more paths, lines, curves, or a combination thereof.

One or more of the wheels 132/134/136/138 may be a steered wheel, which is pivoted to a steering angle under control of the steering unit 110; a propelled wheel, which is torqued to propel the vehicle 100 under control of the transmission 108; or a steered and propelled wheel that steers and propels the vehicle 100.

A vehicle may include units or elements not shown in FIG. 1, such as an enclosure, a Bluetooth® module, a frequency modulated (FM) radio unit, a Near-Field Communication (NFC) module, a liquid crystal display (LCD) display unit, an organic light-emitting diode (OLED) display unit, a speaker, or any combination thereof.

The vehicle, such as the vehicle 100, may be an autonomous vehicle or a semi-autonomous vehicle. For example, as used herein, an autonomous vehicle as used herein should be understood to encompass a vehicle that includes an advanced driver assist system (ADAS). An ADAS can automate, adapt, and/or enhance vehicle systems for safety and better driving such as by circumventing or otherwise correcting driver errors.

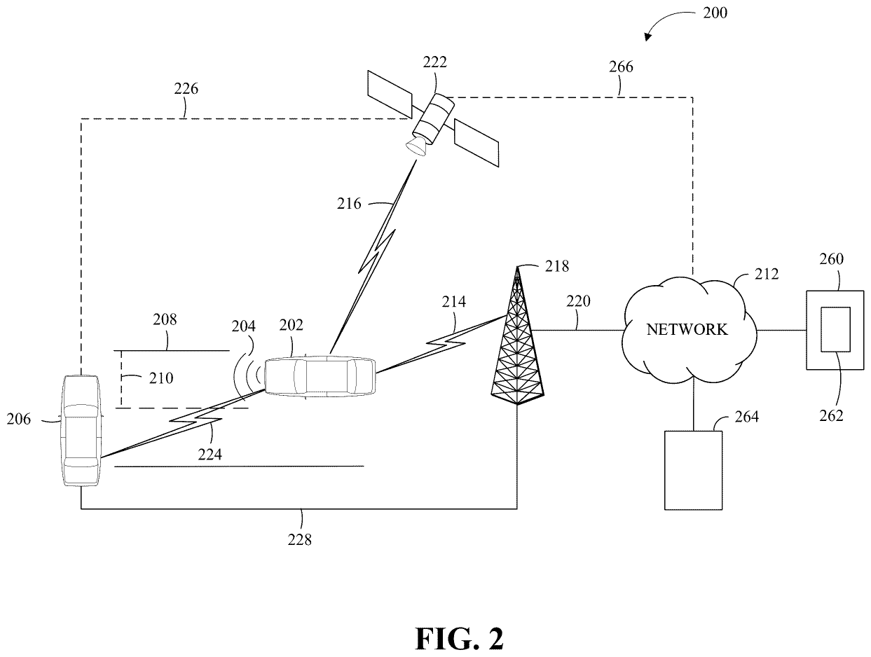

FIG. 2 is a diagram of an example of a portion of a vehicle transportation and communication system 200 in which the aspects, features, and elements disclosed herein may be implemented. The vehicle transportation and communication system 200 includes a vehicle 202, such as the vehicle 100 shown in FIG. 1, and one or more external objects, such as an external object 206, which can include any form of transportation, such as the vehicle 100 shown in FIG. 1, a pedestrian, cyclist, as well as any form of a structure, such as a building. The vehicle 202 may travel via one or more portions of a transportation network 208, and may communicate with the external object 206 via one or more of an electronic communication network 212. Although not explicitly shown in FIG. 2, a vehicle may traverse an area that is not expressly or completely included in a transportation network, such as an off-road area. In some implementations, the transportation network 208 may include one or more of a vehicle detection sensor 210, such as an inductive loop sensor, which may be used to detect the movement of vehicles on the transportation network 208.

The electronic communication network 212 may be a multiple access system that provides for communication, such as voice communication, data communication, video communication, messaging communication, or a combination thereof, between the vehicle 202, the external object 206, and an operations center 230. For example, the vehicle 202 or the external object 206 may receive information, such as information representing the transportation network 208, from the operations center 230 via the electronic communication network 212.

The operations center 230 includes a controller apparatus 232, which includes some or all of the features of the controller 114 shown in FIG. 1. The controller apparatus 232 can monitor and coordinate the movement of vehicles, including autonomous vehicles. The controller apparatus 232 may monitor the state or condition of vehicles, such as the vehicle 202, and external objects, such as the external object 206. The controller apparatus 232 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the controller apparatus 232 can establish remote control over one or more vehicles, such as the vehicle 202, or external objects, such as the external object 206. In this way, the controller apparatus 232 may teleoperate the vehicles or external objects from a remote location. The controller apparatus 232 may exchange (send or receive) state data with vehicles, external objects, or a computing device, such as the vehicle 202, the external object 206, or a server computing device 234, via a wireless communication link, such as the wireless communication link 226, or a wired communication link, such as the wired communication link 228.

The server computing device 234 may include one or more server computing devices, which may exchange (send or receive) state signal data with one or more vehicles or computing devices, including the vehicle 202, the external object 206, or the operations center 230, via the electronic communication network 212.

In some implementations, the vehicle 202 or the external object 206 communicates via the wired communication link 228, a wireless communication link 214/216/224, or a combination of any number or types of wired or wireless communication links. For example, as shown, the vehicle 202 or the external object 206 communicates via a terrestrial wireless communication link 214, via a non-terrestrial wireless communication link 216, or via a combination thereof. In some implementations, a terrestrial wireless communication link 214 includes an Ethernet link, a serial link, a Bluetooth link, an infrared (IR) link, an ultraviolet (UV) link, or any link capable of electronic communication.

A vehicle, such as the vehicle 202, or an external object, such as the external object 206, may communicate with another vehicle, external object, or the operations center 230. For example, a host, or subject, vehicle 202 may receive one or more automated inter-vehicle messages, such as a basic safety message (BSM), from the operations center 230 via a direct communication link 224 or via an electronic communication network 212. For example, the operations center 230 may broadcast the message to host vehicles within a defined broadcast range, such as three hundred meters, or to a defined geographical area. In some implementations, the vehicle 202 receives a message via a third party, such as a signal repeater (not shown) or another remote vehicle (not shown). In some implementations, the vehicle 202 or the external object 206 transmits one or more automated inter-vehicle messages periodically based on a defined interval, such as one hundred milliseconds.

The vehicle 202 may communicate with the electronic communication network 212 via an access point 218. The access point 218, which may include a computing device, is configured to communicate with the vehicle 202, with the electronic communication network 212, with the operations center 230, or with a combination thereof via wired or wireless communication links 214/220. For example, an access point 218 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 202 may communicate with the electronic communication network 212 via a satellite 222 or other non-terrestrial communication device. The satellite 222, which may include a computing device, may be configured to communicate with the vehicle 202, with the electronic communication network 212, with the operations center 230, or with a combination thereof via one or more communication links 216/236. Although shown as a single unit, a satellite can include any number of interconnected elements.

The electronic communication network 212 may be any type of network configured to provide for voice, data, or any other type of electronic communication. For example, the electronic communication network 212 includes a local area network (LAN), a wide area network (WAN), a virtual private network (VPN), a mobile or cellular telephone network, the Internet, or any other electronic communication system. The electronic communication network 212 may use a communication protocol, such as the Transmission Control Protocol (TCP), the User Datagram Protocol (UDP), the Internet Protocol (IP), the Real-time Transport Protocol (RTP), the Hyper Text Transport Protocol (HTTP), or a combination thereof. Although shown as a single unit, an electronic communication network can include any number of interconnected elements.

In some implementations, the vehicle 202 communicates with the operations center 230 via the electronic communication network 212, access point 218, or satellite 222. The operations center 230 may include one or more computing devices, which are able to exchange (send or receive) data from a vehicle, such as the vehicle 202; data from external objects, including the external object 206; or data from a computing device, such as the server computing device 234.

In some implementations, the vehicle 202 identifies a portion or condition of the transportation network 208. For example, the vehicle 202 may include one or more on-vehicle sensors 204, such as the sensor 126 shown in FIG. 1, which includes a speed sensor, a wheel speed sensor, a camera, a gyroscope, an optical sensor, a laser sensor, a radar sensor, a sonic sensor, or any other sensor or device or combination thereof capable of determining or identifying a portion or condition of the transportation network 208.

The vehicle 202 may traverse one or more portions of the transportation network 208 using information communicated via the electronic communication network 212, such as information representing the transportation network 208, information identified by one or more on-vehicle sensors 204, or a combination thereof. The external object 206 may be capable of all or some of the communications and actions described above with respect to the vehicle 202.

For simplicity, FIG. 2 shows the vehicle 202 as the host vehicle, the external object 206, the transportation network 208, the electronic communication network 212, and the operations center 230. However, any number of vehicles, networks, or computing devices may be used. In some implementations, the vehicle transportation and communication system 200 includes devices, units, or elements not shown in FIG. 2.

Although the vehicle 202 is shown communicating with the operations center 230 via the electronic communication network 212, the vehicle 202 (and the external object 206) may communicate with the operations center 230 via any number of direct or indirect communication links. For example, the vehicle 202 or the external object 206 may communicate with the operations center 230 via a direct communication link, such as a Bluetooth communication link. Although, for simplicity, FIG. 2 shows one of the transportation network 208 and one of the electronic communication network 212, any number of networks or communication devices may be used.

The external object 206 is illustrated as a second, remote vehicle in FIG. 2. An external object is not limited to another vehicle. An external object may be any infrastructure element, for example, a fence, a sign, a building, etc., that has the ability transmit data to the operations center 230. The data may be, for example, sensor data from the infrastructure element.

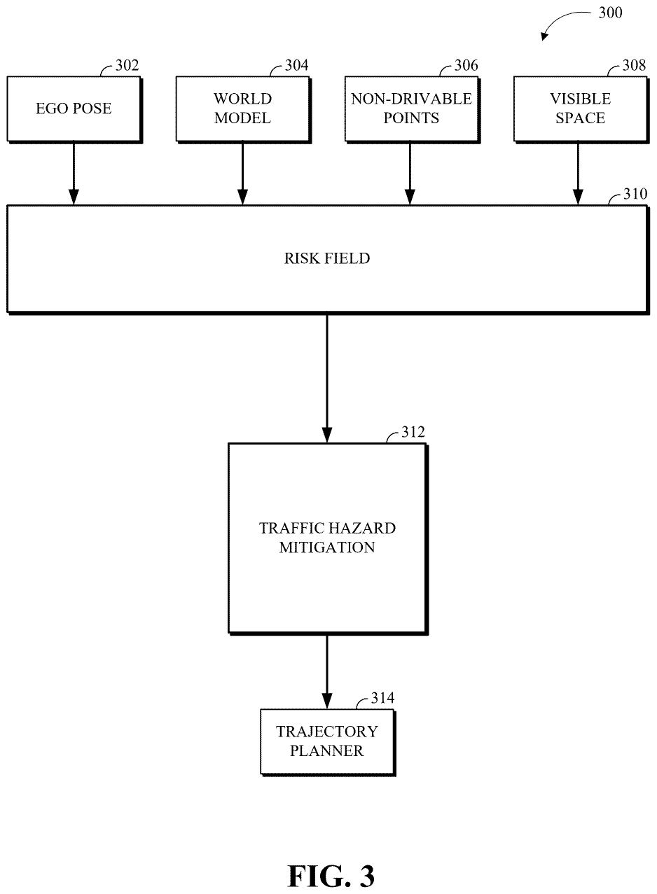

FIG. 3 is an overview of a system 300 for proactive traffic hazard mitigation. Although described with a vehicle traveling through a vehicle transportation network, such as the transportation network 208, the teachings herein may be used in any area navigable by a vehicle, which areas are collectively referred to as a vehicle transportation network. The system 300 includes an ego pose 302, a world model 304, non-drivable points 306, visible space 308, a risk field 310, a traffic hazard mitigation module 312, and a trajectory planner 314. Other examples of the system 300 can include more, fewer, or other components.

The ego pose 302, the world model 304, the non-drivable points 306, and the visible space 308 are received as inputs to the risk field 310. The ego pose 302 refers to the position and orientation of an ego vehicle within a physical environment surrounding the ego vehicle. This includes the coordinates (e.g., latitude and longitude) and heading or direction of travel of the ego vehicle. The ego vehicle may be or be similar to the vehicle 100 of FIG. 1 or the vehicle 202 of FIG. 2.

The world model 304 includes world objects that are classified into different hazard types. The world objects may be classified by a world model module (not shown) of the ego vehicle. For example, a world object may be classified into one of a parked vehicle, a moving vehicle, a moving pedestrian, or a set of non-drivable points, or the like. Non-drivable points 306 correspond to a detected hazard that cannot be classified into a particular type of object. Examples of non-drivable points include trash cans or curbs. The hazards can be categorized into static hazards or dynamic hazards. Static hazards can be hazards that have not been observed moving and are not expected to be moving soon. Dynamic hazards can be either already in motion or have a high probability of moving soon.

For at least some detected world objects (e.g., a vehicle, a pedestrian, or a bicycle), the world model module can maintain (e.g., predict and update) one or more hypothesis regarding the possible intentions of that world object. Examples of intentions (e.g., hypotheses) include stop, turn right, turn left, go straight, pass, and park. A likelihood may be associated with each hypothesis. The likelihood can be updated based on observations received from sensor data. The world objects are detected based on received sensor data (sensor measurements or sensor observations). The world model module maintains (i.e., associates and updates over time) a state for each hypothesis (e.g., intention) associated with a world object. For example, the state may include predicted locations of the associated world object given the intention of a hypothesis. The world model module continuously receives sensor data (sensor observations). For a given observation, the world model module identifies the world object that the observation is associated with. If an associated world object is found, then the state of each of the hypotheses associated with real-world object are updated based on the observation (e.g., based on the consistency of the observation with the hypothesis). That is, for example, the predicted location of the world object is updated based on the observation received from the real (e.g., physical) world. In summary, the world object model can include world objects and their details as fused based on sensor data. The details can include poses, velocities, and predictions regarding different hypotheses.

The visible space 308 is the areas around the ego vehicle that are currently visible to the ego vehicle via a perception module (not shown). The perception module processes sensor data, such as data from the sensor 126 of FIG. 1, from various sources such as but not limited to cameras, light detection and ranging (LiDAR), and radio detection and ranging (RADAR) to determine the areas around the ego vehicle that are currently visible. The visible space can be used to determine, for example, the extent and quality of the sensor coverage around the ego vehicle. Colloquially, the visible space can be used to determine how far and what the ego vehicle can “see.”

The risk field 310 represents a spatially dynamic and data-intensive map-based structure designed to quantify and assess the potential risks in the environment surrounding the ego vehicle. This risk field 310 integrates various inputs, including the ego pose 302, world model 304, non-drivable points 306, and visible space 308, to provide a comprehensive view of detected hazards. The risk field 310 aggregates and categorizes data from detected hazards. The risk field 310 accounts for static hazards, such as but no limited to curbs or trash cans, and dynamic hazards, such as but not limited to moving vehicles or pedestrians, by continuously updating probabilities of their presence within defined grid cells. Additionally, the risk field 310 leverages sensor data and predictions regarding potential object interactions, such as possible collisions or proximity to the ego vehicle, to dynamically adjust the risk representation over time.

The traffic hazard mitigation module 312 receives and processes the risk field 310, along with the reference path and speed plan of the ego vehicle. The traffic hazard mitigation module 312 identifies relevant hazards, such as but not limited to a lead vehicle, an adjacent vehicle, or a non-drivable point in the environment based on the risk field 310. The traffic hazard mitigation module 312 determines the location of relevant hazards by analyzing a width of the risk field 310. The width of the risk field 310 extends laterally on both the left and right sides of the reference path of the ego vehicle for each unit distance. A unit distance may be a 0.5 m×0.5 m grid within the risk field; however, any other suitable unit distance can be used. The relevant hazards for each unit distance of the reference path are stored by the traffic hazard mitigation module 312.

Using the relevant hazards, the traffic hazard mitigation module 312 calculates base parameters. The base parameters are the average speed difference between the ego vehicle and the relevant hazards, the density of relevant hazards (e.g., adjacent vehicles) per unit distance and the average lateral distance between the ego vehicle and the relevant hazards. Once the traffic hazard mitigation module 312 has determined the base parameters, the traffic hazard mitigation module 312 can calculate a risk level using the base parameters. The risk level represents the likelihood of a hazardous event occurring in the presence of relevant hazards. For example, the risk level may be determined based on a weighted combination of the base parameters. The weights may be determined based on historical incident data or learned from labeled training data.

Once the traffic hazard mitigation module 312 calculates the risk level, a speed constraint can be generated based on the risk level. The speed constraint is a limitation or restriction that can be used to reduce the maximum speed of ego vehicle. After generating the speed constraint, the traffic hazard mitigation module 312 passes the speed constraint to the trajectory planner 314. The trajectory planner 314 uses the speed constraint to limit the maximum speed of the ego vehicle for a planned trajectory. For example, the trajectory planner may generate a straight path that avoids the relevant hazards while adhering to the speed constraint. The speed constraint is continuously adjusted based on the changing risk level, allowing the ego vehicle to adapt to dynamic environments and maintain a safe speed in relation to the relevant hazards.

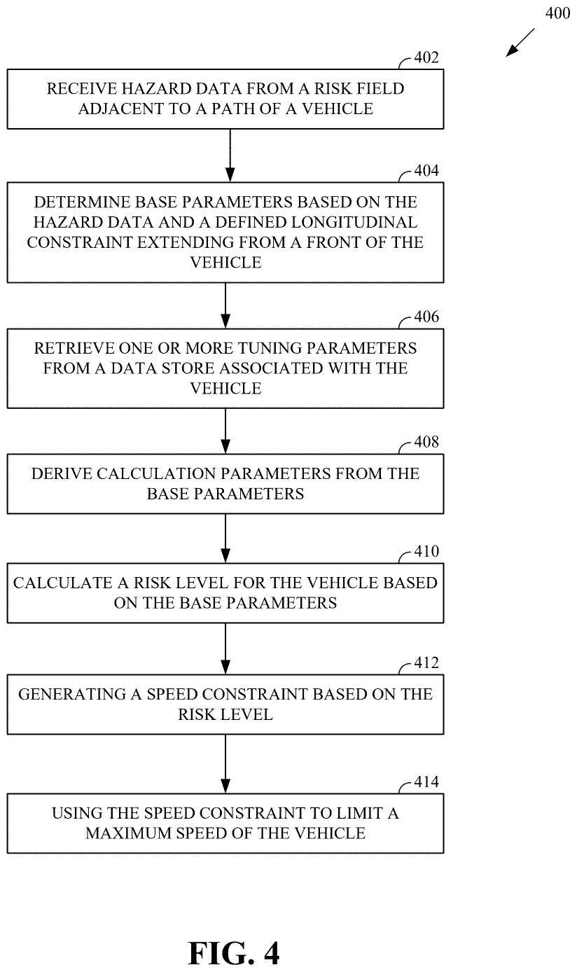

FIG. 4 is a flowchart diagram of an example of a technique 400 for mitigating traffic hazards in accordance with an implementation of this disclosure. The technique 400 can be implemented, partially or fully, by a vehicle, such as the vehicle 202 as described with respect to FIG. 2. The technique 400 can be implemented in an AV, which can be the vehicle 100 shown in FIG. 1, one of the vehicles 202/206 shown in FIG. 2, a semi-autonomous vehicle, or any other vehicle that includes drive-assist capabilities, including remote control of the vehicle. The technique 400 can be implemented as instructions that are stored in a memory, such as the memory 122 of FIG. 1. The instructions can be executed by a processor, such as the processor 120 of FIG. 1. The technique 400 may be performed in whole or in part by hardware.

At 402, hazard data is received from a risk field adjacent to a path of a vehicle. The risk field may be or be similar to the risk field 310 of FIG. 3. The risk field may be received by a traffic hazard mitigation module such as the traffic hazard mitigation module 312 of FIG. 3. The vehicle may be or be similar to the vehicle 202 of FIG. 2. The risk field extends laterally from either side of the path. In certain implementations, the risk field extends laterally for 6 meters (m) on either side of the path. However, in some implementations, the risk field may extend less than 6 m. In another implementation, the risk may extend further than 6 m. Upon receiving the risk field, the technique 400 parses the hazard data accumulated within the risk field. The technique 400 may parse the data by identifying relevant hazards such as but not limited to lead vehicles, adjacent vehicles, or non-drivable vehicles for each unit distance of the reference path. The relevant hazards are then stored by the technique 400 for each unit distance.

At 404, base parameters are determined based on the hazard data and a defined longitudinal constraint that extends from a front of the vehicle. That is the technique 400 determines dv, ρ, and dy, in which dv is the average speed difference between the speed limit of the road and the relevant hazards. The average speed difference dv can be represented by equation (1).

$$dv = {v}_{m ax} - {v}_{avg} \qquad ( 1 )$$

Here, vₘₐₓ is the speed limit of the road the vehicle is traveling on and v_{avg} is the average speed of the relevant hazards. The base parameter ρ is the density of relevant hazards (e.g., adjacent vehicles) per unit distance and dy is the average lateral distance between the ego vehicle and the relevant hazards. In certain implementations, the defined longitudinal constraint is 50 m from the front of the vehicle. In some implementations, the defined longitudinal constraint is less than 50 m from the front of the vehicle. In other implementations, the defined longitudinal constraint is greater than 50 m from the front of the vehicle.

The longitudinal constraint is a sliding window that moves along the path of the vehicle. The sliding window has a leading edge and a trailing edge. The distance between the leading edge and the trailing edge of the sliding window is the longitudinal constraint. The sliding window moves along the path of the vehicle such that the leading edge of the sliding window is always ahead of the vehicle. For example, dv at 0 m ahead of the vehicle may be calculated using the relevant risks identified within the risk field for 0 m-50 m ahead of the vehicle. In another example, dv at 1 m ahead of the vehicle may be calculated using the relevant risks identified within the risk field for 1 m-51 m ahead of the vehicle. The base parameters may be calculated in this manner as the sliding window moves along the path of the vehicle until the maximum lookahead distance. In certain implementation, the maximum lookahead distance is 200 m. In some implementations, the maximum lookahead distance is less than 200 m. In other implementations, the maximum lookahead distance is greater than 200 m. The maximum lookahead distance is constrained by the sensors of the vehicle such as the sensor 126 of FIG. 1.

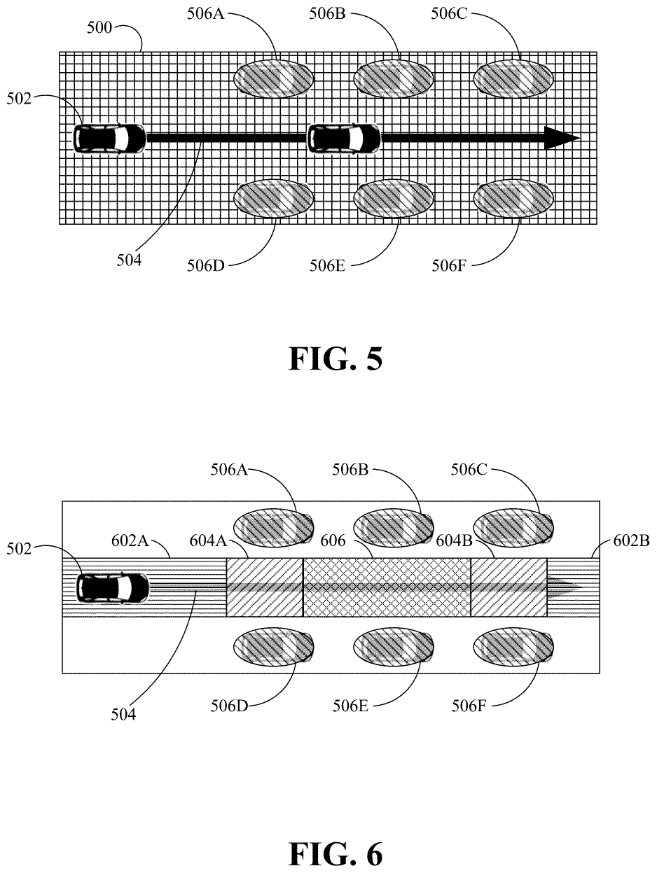

FIG. 5 is an illustration of a representation of identified relevant hazards within the risk field. The illustration depicts a risk field 500. The risk field 500 is depicted as showing a grid to indicate the unit distance of a reference path 504 of the vehicle 502. The risk field 500 may be or be similar to the risk field 310 of FIG. 3. The vehicle 502 may be or be similar to the vehicle 202 of FIG. 2. The reference path 504 indicates the current path of the vehicle 502. The illustration further depicts relevant hazards 506A-506F. The relevant hazards 506A-506F are vehicles adjacent to the reference path 504 of the vehicle 502. While the relevant hazards are depicted as vehicles adjacent to the reference path 504, in some implementations, the relevant hazards may be lead vehicles, non-drivable points, or the like. Additionally, FIG. 5 is intended to be illustrative and is not necessarily drawn to scale.

The relevant hazards 506A-506F may be the relevant hazards identified at 402. As such, the relevant hazards 506A-506F may be used to determine base parameters, such as the base parameters described at 404 of FIG. 4. For example, given the longitudinal constraint of 50 m, the base parameters can be calculated along the reference path 504 from the front of the vehicle 502. For instance, the base parameter dv can be calculated by finding the difference between the speed limit at which each relevant hazard 506A-506F is travelling and taking the difference between the respective speed of each relevant hazard and the speed limit of the road on which the vehicle is travelling. The sum of the respective differences for each relevant hazard 506A-506F is then divided by the number of relevant hazards 506A-506F resulting in the base parameter dv.

The base parameter dy can be calculated is a similar manner to that of dv. For instance, the base parameter dy can be calculated by finding the lateral distance between each relevant hazard 506A-506F and the vehicle. The sum of the lateral distances for each relevant hazard 506A-506F is then divided by the number of relevant hazards 506A-506F resulting in the base parameter dy. The base parameter ρ can be calculated using the hazard data and the defined longitudinal constraint. For example, assuming there are six (6) relevant hazards, such as the relevant hazards 506A-506F, within the longitudinal constraint of 50 m then p can be represented by equation (2).

$$ρ = \frac{N}{L} \qquad ( 2 )$$

Here N is the number of relevant hazards within the longitudinal constraint L.

Referring again to FIG. 4, at 406 one or more tuning parameters may be retrieved from a data store associated with the vehicle. The data store may be stored using the memory 122 of FIG. 1. The data store may be a file system, such as a network file system (NFS) or a server message block (SMB). Alternatively, the data store may be a database, such as a relational database (e.g., MySQL, PostgreSQL, or Oracle) or a NoSQL database (e.g., MongoDB, Cassandra, or Neo4j). The data store may also be in the form of cloud storage, such as Amazon S3, Google Cloud Storage, or Azure Blob Storage. Yet another form of the data store is an in-memory database or data structure.

The tuning parameters may be associated with a profile such as a profile of a driver of the vehicle or a default profile. The profile may include parameters related to the preferred driving style of the driver, such as the preferred following distance, acceleration, and deceleration rates of the driver. The tuning parameters may be used to customize the behavior of the traffic hazard mitigation modules to better match the preferences of the driver.

In some implementations, the tuning parameters can be derived, using a learning-based approach, through machine learning algorithms. This allows the system to customize the tuning parameters to a preferred driving style of an individual driver based on the past driving behavior of the individual driver. The machine learning model starts with default weights and parameters for online model prediction. As the vehicle is driven manually, more data is collected, and the model is trained offline to adapt to the speed preferences of the individual driver. This iterative learning process allows the system to progressively refine the tuning parameters, resulting in a more personalized and effective traffic hazard mitigation strategy.

In some implementations, the tuning parameters are derived using a 4-layer multi-layer perceptron (MLP) model. The MLP model is first trained on a dataset of driving scenarios, with the input features being the metrics computed from parsing the risk field, such as traffic density, average lateral distance to adjacent cars, and average speed difference between the speed limit of the road and the relevant hazards. The output of the MLP model would be the desired speed constraint for a given scenario, reflecting the preferred driving style of the individual driver. The model is trained to minimize the difference between its predicted speed constraint and the actual speed chosen by the driver in past driving experiences. Once trained, the MLP model can then produce tuning parameters that can be used to adjust the speed constraints generated by the traffic hazard mitigation module, allowing for personalized speed control that is tailored to the preferences of the individual driver.

At 408 calculation parameters are derived from the base parameters. That is the technique 400 uses the base parameters to calculate calculation parameters that are then used for calculating the risk level. The calculation parameters are I (i.e., impact) which indicates the level (i.e., amount) of damages that can be expected (i.e., incurred) if the worst-case scenario occurs (i.e., collision). P (i.e., probability) which is the chance that worst-case scenario will occur, and L (i.e., lateral distance factor) which represents the reaction time that would be needed to avoid a collision. The calculation parameter I is derived from the base parameter dv as represented by equation (3).

$$I = {f}_{I} ( d v ) = \{ \begin{matrix}0 , & dv < 2.2 \\ \frac{dv - 2.2}{8.94} , & 2.2 \leq dv \leq 11.14 \\ 1 , & dv > 11.14\end{matrix} \qquad ( 3 )$$

Here the constants 2.2 and 11.14 are default values for two of the tuning parameters associated with the default profile. The constants 2.2 and 11.14 may be replaced with customized values associated with a profile of the driver.

The calculation parameter P is derived from the base parameter ρ as represented by equation (4).

$$P = {f}_{P} ( ρ ) = \{ \begin{matrix}\frac{ρ}{0.1} , & 0 < ρ \leq 0.1 \\ 1 , & ρ > 0.1\end{matrix} \qquad ( 4 )$$

Here the constant 1.1 is a default value for another turning parameters associated with the default profile. The constant 1.1 may be replaced with a customized value associated with profile of the driver.

The calculation parameter L is derived from the base parameter dy as represented by equation (5).

$$L = {f}_{L} ( d y ) = \{ \begin{matrix}1 , & dy < 2 \\ ( 4 - dy ) 0.5 , & 2 \leq dy \leq 4 \\ 0 , & dy > 4\end{matrix} \qquad ( 5 )$$

Here the constants 2 and 4 and another example of tuning parameters associated with the default profile. The constants 2 and 4 may be replaced with customized values associated with a profile of the driver.

At 410, a risk level is calculated for the vehicle based on the base parameters. That is the technique 400 uses the base parameters to derive the calculation parameters then calculates the risk level using the calculation parameters. The risk level indicates the likelihood or severity of potential hazards or unfavorable events associated with the current driving situation of the vehicle. The risk level r is derived using a product of the calculation parameters as represented by equation (6).

$$r = {f}_{r} ( P , I , L ) = P * I * L \qquad ( 6 )$$

The risk level reflects both the likelihood and severity of the potential hazards.

FIG. 6 is an illustration of a representation of a calculated risk level. The illustration depicts the vehicle 502, the reference path 504, the relevant hazards 506A-506F, and the calculated risk levels 602A, 602B, 604A, 604B, and 606. The vehicle 502 may be or be similar to the vehicle 202 of FIG. 2. The reference path 504 indicates the current path of the vehicle 502. Additionally, FIG. 6 is intended to be illustrative and is not necessarily drawn to scale. The calculated risk levels correspond to different sections of the reference path 504 at different points in time as the vehicle 502 traverse the reference path 504. The calculated risk levels 602A and 602B represent a low risk level. The calculated risk levels 604A and 604B represent an elevated risk level and the calculated risk level 606 represents the highest risk level relative to the reference path. For example, the calculated risk levels 602A-602B may be 0.0, the calculated risk levels 604A-604B may be 0.5, and the calculated risk level may be 1.0.

Referring again to FIG. 4, at 412, a speed constraint is generated based on the risk level. In other words, the traffic hazard mitigation module translates the risk level into a maximum safe speed for traversing the section of the path associated with the calculated risk level. The speed constraint may be represented by equation (7).

$${v}_{ma x}^{*} = {v}_{ma x} - 6.7 r \qquad ( 7 )$$

Here the constant 6.7 is a default value for another turning parameters associated with the default profile. The constant 6.7 may be replaced with a customized value associated with profile of the driver.

By translating the risk level into a maximum safe velocity, the traffic hazard mitigation modules enabled the vehicle to dynamically adjust its speed in response to the calculated level of risk. This proactive approach to speed regulation enhances the safety of the vehicle by ensuring that the vehicle operates within safe speed limits, given the current environmental conditions and potential hazards.

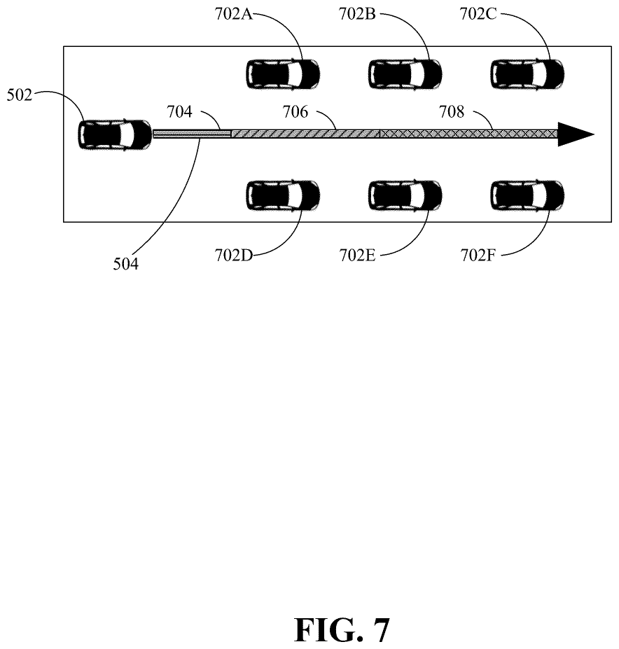

FIG. 7 is an illustration of a speed constraint based on the identified relevant hazards. The illustration depicts the vehicle 502, the reference path 504, other vehicles 702A-702F, and speed constraints 704, 706, and 708. The other vehicles 702A-702F may be or be similar to the relevant hazards 506A-506F of FIG. 5. At a minimum the other vehicles 702A-702F may be what the relevant hazards 506A-506F are based on. The speed constraints 704, 706 and 708 are visual representations of the different speed constraints as the level of risk increases.

For example, the speed constraint 704 may represent a speed constraint generated in response to a low risk level, such as the risk level associated with calculated risk level 602A or the calculated risk level 602B of FIG. 6. The speed constraint 706 may represent a speed constraint generated in response to an elevated risk level, such as the calculated risk level 604A or the calculated risk level 604B of FIG. 6. The speed constraint 708 may represent a speed constraint generated in response to the highest risk level, such as the calculated risk level 606 of FIG. 6. The speed constraints 704, 706, and 708 are shown as encompassing a portion of the reference path 504. The length of the speed constraint along the reference path 504 can vary depending on the severity and proximity of the relevant hazards. For instance, a higher risk level or closer proximity of relevant hazards may result in a longer speed constraint along the reference path 504.

Referring again to FIG. 4, at 414, The speed constraint is used to limit the maximum speed of the vehicle. That is, a control system of the vehicle may apply the speed constraint to a planned trajectory of the vehicle. The control system of the vehicle may be the controller 114 of FIG. 1. This may involve passing the speed constraint to the trajectory planner, such as the trajectory planner 314 of FIG. 3, of the vehicle. The control system coordinates the movements of the vehicle to the imposed speed constraint. This involves the trajectory planner integrating the speed constraint into its calculations and generating a modified trajectory that adheres to the new speed limit. The control system then executes the modified trajectory, effectively controlling the acceleration and deceleration of the vehicle to maintain a safe speed.

Herein, the terminology “passenger”, “driver”, or “operator” may be used interchangeably. Also, the terminology “brake” or “decelerate” may be used interchangeably. As used herein, the terminology “processor”, “computer”, or “computing device” includes any unit, or combination of units, capable of performing any method, or any portion or portions thereof, disclosed herein.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some embodiments, instructions, or a portion thereof, may be implemented as a special-purpose processor or circuitry that may include specialized hardware for carrying out any of the methods, algorithms, aspects, or combinations thereof, as described herein. In some embodiments, portions of the instructions may be distributed across multiple processors on a single device, or on multiple devices, which may communicate directly or across a network, such as a local area network, a wide area network, the Internet, or a combination thereof.

As used herein, the term “memory subsystem” includes one or more memories, where each memory may be a computer-readable medium. A memory subsystem may encompass memory hardware units (e.g., a hard drive or a disk) that store data or instructions in software form. Alternatively, or in addition, the memory subsystem may include data or instructions that are hard-wired into processing circuitry.

As used herein, the terminology “example,” “embodiment,” “implementation,” “aspect,” “feature,” or “element” indicate serving as an example, instance, or illustration. Unless expressly indicated otherwise, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or.” That is, unless specified otherwise or clearly indicated otherwise by the context, “X includes A or B” is intended to indicate any of the natural inclusive permutations thereof. If X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of operations or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and/or elements.

While the disclosed technology has been described in connection with certain embodiments, it is to be understood that the disclosed technology is not to be limited to the disclosed embodiments but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method, comprising:
receiving hazard data from a risk field adjacent to a path of a vehicle, wherein a width of the risk field extends laterally from the vehicle in both directions and the hazard data is stored for each unit distance of the path;
determining base parameters based on the hazard data and a defined longitudinal constraint extending from a front of the vehicle, wherein the base parameters include at least one of an average speed difference, an average lateral distance, or a density of adjacent vehicles per unit distance;
calculating a risk level for the vehicle based on the base parameters;
generating a speed constraint based on the risk level; and
using the speed constraint to limit a maximum speed of the vehicle.

2. The method of claim 1, wherein the hazard data includes one or more hazards, and the one or more hazards are classified as at least one of a lead vehicle, an adjacent vehicle, or a non-drivable point.

3. The method of claim 1, comprising:
deriving calculation parameters from the base parameters, wherein the calculation parameters are used to calculate the risk level.

4. The method of claim 3, wherein the calculation parameters include at least an impact, a probability, and a lateral distance factor.

5. The method of claim 4, wherein the probability is derived from the density of adjacent vehicles per unit distance and represents a likelihood of an adjacent vehicle merging into the path.

6. The method of claim 4, wherein the impact is derived from the average speed difference and indicates an amount of damage to be incurred.

7. The method of claim 1, comprising:
retrieving one or more tuning parameters from a data store associated with the vehicle, wherein the risk level is calculated using the one or more tuning parameters.

8. The method of claim 7, wherein the speed constraint is generated using the one or more tuning parameters.

9. An apparatus, comprising:
a memory subsystem; and
one or more processors configured to execute instructions stored in the memory subsystem to:
receive hazard data from a risk field adjacent to a path of a vehicle, wherein a width of the risk field extends laterally from the vehicle in both directions and the hazard data is stored for each unit distance of the path;
determine base parameters based on the hazard data and a defined longitudinal constraint extending from a front of the vehicle, wherein the base parameters include at least one of an average speed difference, an average lateral distance, or a density of adjacent vehicles per unit distance;
calculate a risk level for the vehicle based on the base parameters;
generate a speed constraint based on the risk level; and
use the speed constraint to limit a maximum speed of the vehicle.

10. The apparatus of claim 9, wherein the hazard data includes one or more hazards, and the one or more hazards are classified as at least one of a lead vehicle, an adjacent vehicle, or a non-drivable point.

11. The apparatus of claim 9, wherein the one or more processors are further configured to execute instructions to:
derive calculation parameters from the base parameters, wherein the calculation parameters are used to calculate the risk level.

12. The apparatus of claim 11, wherein the calculation parameters include at least an impact, a probability, and a lateral distance factor.

13. The apparatus of claim 12, wherein the probability is derived from the density of adjacent vehicles per unit distance and represents a likelihood of an adjacent vehicle merging into the path.

14. The apparatus of claim 12, wherein the impact is derived from the average speed difference and indicates an amount of damage to be incurred.

15. The apparatus of claim 9 wherein the one or more processors are further configured to execute instructions to:
retrieve one or more tuning parameters from a data store associated with the vehicle, wherein the risk level is calculated using the one or more tuning parameters.

16. The apparatus of claim 15, wherein the speed constraint is generated using the one or more tuning parameters.

17. A non-transitory computer-readable medium storing instructions operable to cause one or more processors to perform operations comprising:
receiving hazard data from a risk field adjacent to a path of a vehicle, wherein a width of the risk field extends laterally from the vehicle in both directions and the hazard data is stored for each unit distance of the path;
determining base parameters based on the hazard data and a defined longitudinal constraint extending from a front of the vehicle, wherein the base parameters include at least one of an average speed difference, an average lateral distance, or a density of adjacent vehicles per unit distance;
deriving calculation parameters from the base parameters, wherein the calculation parameters include at least an impact of an amount of damage to be incurred by the vehicle, a probability of an adjacent vehicle merging into the path, and a lateral distance factor;
calculating a risk level for the vehicle using the calculation parameters;
generating a speed constraint based on the risk level; and
using the speed constraint to limit a maximum speed of the vehicle.

18. The non-transitory computer-readable medium of claim 17, wherein the probability is derived from the density of adjacent vehicles per unit.

19. The non-transitory computer-readable medium of claim 17, wherein the impact is derived from the average speed difference.

20. The non-transitory computer-readable medium of claim 17, the operations further comprising:
retrieving one or more tuning parameters from a data store associated with the vehicle, wherein the risk level is calculated using the one or more tuning parameters and the speed constraint is generated using the one or more tuning parameters.
